(19) United States
(12) Patent Application Publication
(10) Pub. No.: US 2009/0163256 A1
(43) Pub. Date: Jun. 25, 2009

(54) TRANSLUCENT SINGLE LAYER TOUCH SCREEN DEVICES HAVING VERTICALLY ORIENTED PATTERN TRACES

(75) Inventor: MATTHEW B. WIENKE, HIGHLAND PARK, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/962,466

(22) Filed: Dec. 21, 2007

(51) Int. Cl. H04M 1/00; G06F 3/041

(52) U.S. Cl. 455/575.3; 345/173

(57) ABSTRACT

Disclosed is a translucent single layer touch screen device of a mesh composed of a low resistive material is configured so that the length of the pattern traces of the disclosed semi-transparent touch screen are arranged in the vertical direction, their circuitry terminating at one edge of the mesh. In a clam shell form factor mobile communication device, the circuitry coupled to the pattern traces of the mesh to receive touch signals is proximal the hinge edge, which is covered by artwork. There is no need for silver ink or other circuitry at the other edges of the mesh so that the above-described semi-transparent touch screen beneficially does not include any artwork on the other edges. Also disclosed are embodiments including rotator and slider form factors including the disclosed touch screen configuration. Accordingly, the disclosed unframed semi-transparent touch screen may provide advanced features and maintain an edge in design trends.

### CROSS REFERENCE TO RELATED APPLICATIONS

This application is related to co-pending U.S. patent application Ser. No. XX/YYY,YYY, “Translucent Touch Screen Devices Including Low Resistive Mesh” (Attorney Docket No. CS33778RL), filed Dec. 21, 2007, and to co-pending U.S. patent application Ser. No. XX/YYY,YYY, “Translucent Touch Screens Including Invisible Electronic Component Connections” (Attorney Docket No. CS33777RL), filed Dec. 21, 2007, both of which are incorporated by reference herein in their entirety.

### FIELD

Disclosed are devices for touch input and methods for forming devices for touch input, and more particularly, translucent touch screen devices for use with mobile communication devices and methods for forming translucent devices for touch input.

### BACKGROUND

Mobile communication devices are a part of everyday life. Users may have more than one mobile communication device, and may trade in models yearly to own those with current design trends and up-to-date functionality. Manufacturers are constantly striving to include advanced features in their mobile communication devices as well as maintain a design edge. While there is a trend toward the inclusion of more features and improvements for current features, there is also a design trend toward smaller mobile communication devices. It would be desirable while providing advanced features and maintaining an edge in design trends, to also make improvements to reduce manufacturing costs.

A popular design trend is the translucent touch screen. For example, in a clam shell form factor device, a substantially transparent touch screen may be included on the flip of the device. The main display on the main housing may be viewed through the touch screen of the flip so that a user may utilize menus of the main display without placing the clam shell device in the open position. For example, the translucent touch screen may include discrete buttons or touch zones which when touched are responsive to indicia on the main display.

Indium tin oxide (ITO) has been utilized for semi-transparent capacitive touch screens. In translucent ITO touch screens, patterns are formed to provide activation points or zones on the touch screen. Typically, opaque silver ink is used to form signal traces from the activation zones to a printed circuit board (PCB) or other circuitry component linked to the controller of the device, because ITO has too high a resistance to be useful for such signal traces (although useful for touch zones due to its translucence). A touch zone is formed by pattern traces which are formed by microscopic cuts to isolate the zones from one another. In a standard touch screen size of approximately 40 mm by approximately 60 mm, a single layer ITO touch screen may include up to eight physical touch zones or buttons without using opaque silver ink signal traces to connect to the PCB. Such an eight button ITO touch screen, without opaque silver ink signal traces, would require such wide trace widths to reduce the resistance of the signal traces to a usable value that approximately half of the area of the touch screen would be needed for signal traces, leaving only about half of the area available for touch zones, thus reducing the touch input area significantly. The touch screen may include up to several thousand virtual touch input points, needed for full XY touch screens with virtual buttons anywhere on the screen, when using opaque silver ink signal traces to connect to the PCB.

Because of the necessity of silver ink, the ITO semi-transparent touch screens however, are not completely translucent. Pattern traces of ITO touch screens require non-transparent silver ink at their termination points which are along the edges of the touch screen. The opacity of the silver ink can detract from the translucent look of the touch screen, and often the silver ink may therefore be concealed by artwork. Thus, since the length of the ITO pattern traces are positioned in the horizontal direction, that is, widthwise across the flip of a clam shell form factor mobile communication device, the ITO touch screens are framed by artwork to hide the silver ink at the edges. Accordingly, due to the artwork at the edges, the ITO touch screens are not truly semi-transparent.

The pattern traces of single layer ITO touch screens measure the vertical position of a finger or conductive stylus using a continuous signal trace from the screen's top to bottom with horizontally aligned segments. The signal trace resistance of an ITO touch screen increases as the length of the trace increases. The touch screen controller measures input at several points along this signal trace and takes into account the trace's resistance to calculate the vertical position of a finger or stylus on the touch screen. The traces used to measure input along the resistive signal trace run along the sides of the one layer ITO touch screen pattern. While semi-transparent touch screens made using ITO are gaining popularity, improvements in semi-transparent touch screens are desirable.

### BRIEF DESCRIPTION OF THE DRAWINGS

FIG. 1 depicts a mobile communication device having a clam shell form factor, where the disclosed semi-transparent or translucent touch screen device is incorporated into the flip, and indicia on the main display of the main housing are visible through the disclosed touch screen;

FIG. 2 illustrates pattern traces of the disclosed translucent touch screen device including a near-see-through mesh wherein pattern traces are perpendicular to the hinge edge of the flip housing; and

FIG. 3 depicts the disclosed mesh of a low resistive material utilized for the disclosed touch screen shown as an enlargement thereof.

### DETAILED DESCRIPTION

It would be beneficial if a semi-transparent touch screen were transparent on most edges to provide an unframed look. On a clam shell form factor device, it would also be beneficial if substantially all circuitry of the pattern traces were hidden by artwork proximal the hinge. It would in addition be beneficial to provide advanced features while maintaining a design edge.

The disclosed touch screen utilizing a low resistive material such as copper can be semi-transparent and is used in a second housing of a mobile communication device having circuitry to receive touch signals to control at least one function of mobile communication device incorporating the touch screen device. The mobile communication device includes two joined housings, the first housing including a main display screen and the second housing including the disclosed touch screen. The disclosed semi-transparent touch screen device is configured so that an adjacent main display screen is visible through the touch screen device. Input received by the touch screen device is responsive to indicia displayed on the display screen. Since the disclosed touch screen incorporating a mesh having a low resistivity value may include many more discrete touch zones than possible with an ITO screen, without opaque silver ink signal traces, beneficially the functionality of the device in the closed position is improved over a device utilizing an ITO touch screen.

The low resistivity of the mesh of the disclosed touch screen beneficially may allow pattern traces to be of a smaller width than that of ITO, and therefore may allow more touch zones per specified area than are possible with ITO. The pattern traces are vertically aligned so that they are perpendicular for example to the hinge edge of a clam shell form factor device. To measure horizontal position of a finger, for example, resistors are utilized in the disclosed touch screen. The resistors may be added under the hinge artwork on a PCB with a controller IC for the touch screen.

The disclosed translucent touch screen device of a mesh composed of a low resistive material is configured so that the length of the pattern traces of the disclosed semi-transparent touch screen are arranged perpendicular for example to the hinge edge of a clam shell form factor device so that their circuitry terminates at one edge of the mesh. As mentioned, there is no need for silver ink or other circuitry at the other edges of the mesh so that the above-described semi-transparent touch screen beneficially does not include any artwork to cover circuitry on most edges of the touch screen. Accordingly, the disclosed unframed semi-transparent touch screen may provide advanced features and maintain an edge in design trends.

The length of the pattern traces of the disclosed semi-transparent touch screen are beneficially arranged in the vertical direction, their circuitry terminating at one edge of the mesh. In a clam shell form factor device, the circuitry terminates proximal the hinge portion of the flip. Since there is no need for silver ink or other circuitry at the edges, the above-described semi-transparent touch screen beneficially does not include any artwork except on one edge of the second housing. The circuitry coupled to the pattern traces of the mesh to receive touch signals terminates proximal the hinge edge, which is routinely covered by artwork. Also disclosed are embodiments including rotator and slider form factors including the disclosed touch screen configuration. Beneficially, positioning the length of the pattern traces of the disclosed semi-transparent touch screen of a low resistive mesh vertically with respect to the length of a housing for the semi-transparent touch screen allows for an aesthetically pleasing unframed touch screen, having artwork covering the circuitry on a single edge of the touch screen.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

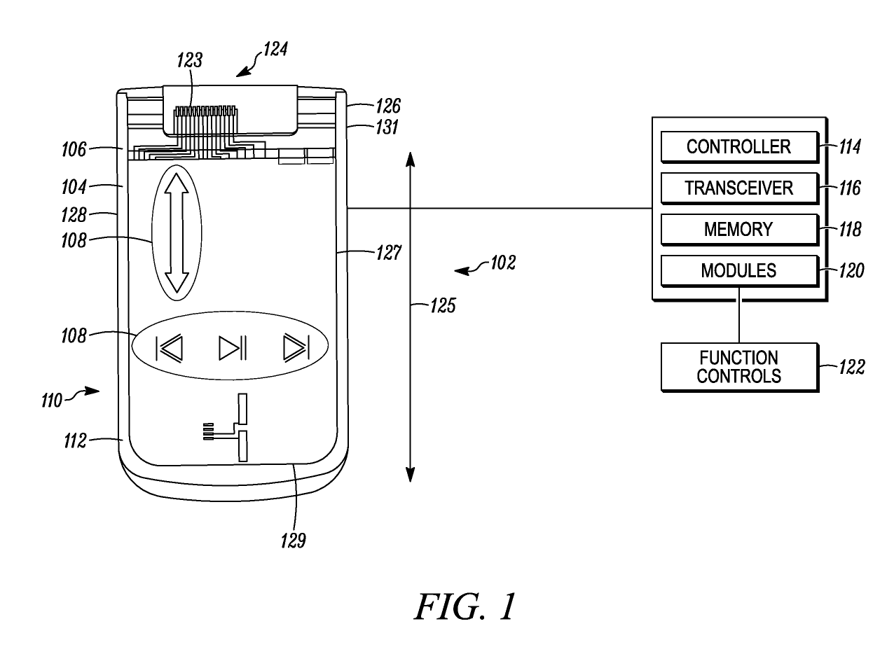

FIG. 1 depicts a mobile communication device 102 having a clam shell form factor, where the disclosed semi-transparent, or translucent touch screen device 104 is incorporated into the flip 106 and indicia 108 on the main display 110 of the main housing 112 are visible through the disclosed touch screen 104. While the disclosed touch screen is discussed with respect to utilization in a mobile communication device having a clam shell form factor flip housing, it is understood that the disclosed touch screen device may be used in conjunction with a slider form factor and a rotator form factor. It is further understood that the disclosed touch screen may be utilized in any suitable electronic device, and the present discussion is not intended to limit its many possible uses.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

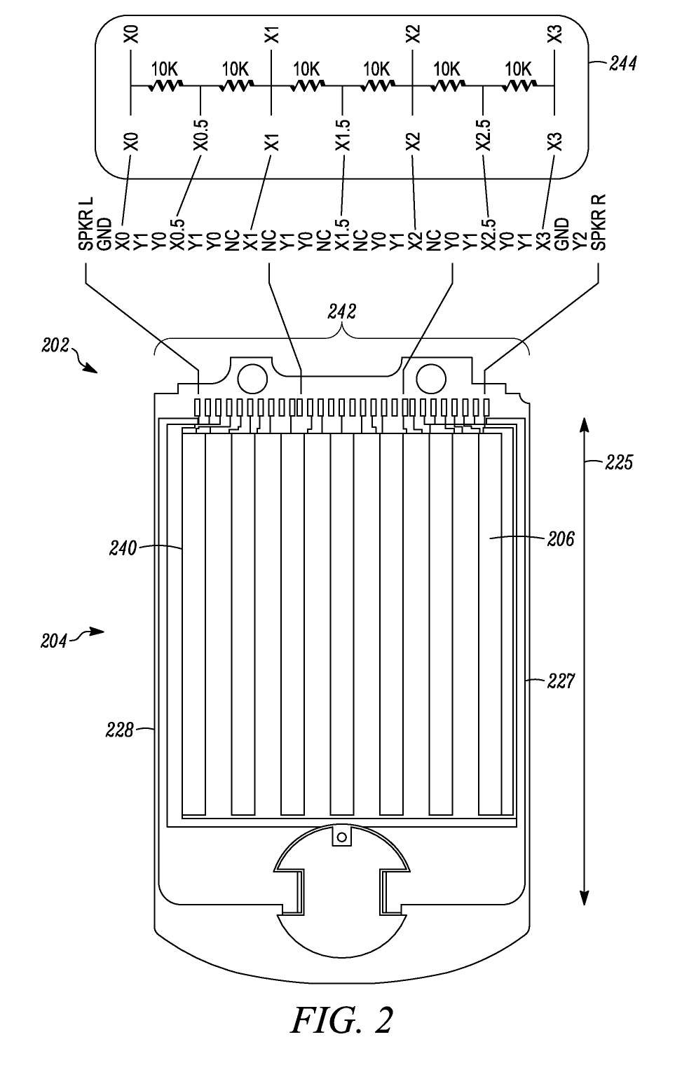

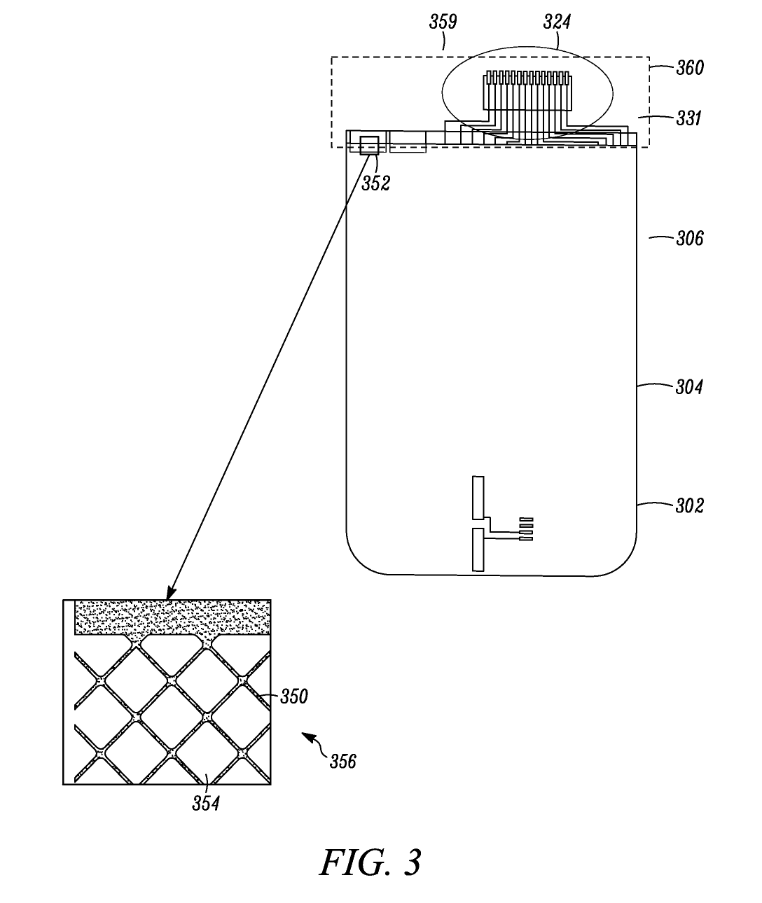

The mobile communication device 102 can include a controller 114, at least one transceiver 116, a memory 118 and modules 120, for example function control modules 122. The circuitry 124 may be hot bonded to a flex tail 123 that is coupled to the pattern traces (see FIG. 2) of the mesh (see FIG. 3) to receive touch signals generated by touch input. The circuitry 124 is further coupled to a controller 114 to control at least one function of the mobile communication device according to the touch signals. The at least one function control is represented by the function control module 122. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below. In the embodiment depicted in FIG. 1, the function control module is generalized to control any designated function of the mobile communication device 102.

Visually suppressed mesh pattern traces (depicted in FIG. 2) are touch zones that are utilized to process touch input. For example, touch input includes the touch of a user's finger or of a conductive stylus. It is understood that any suitable pattern traces may be formed, and that those depicted are example pattern traces. Circuitry 124 may receive touch signals received via the pattern traces, the circuitry 124 being coupled to the controller 114 to control at least one function 122 of the electronic device 102, for example, controls for music playback such as volume controls.

In a clam shell form factor device the circuitry 124 can be proximal the hinge 126 and therefore may be hidden by the artwork normally proximal the hinge 126. Since the pattern traces (see FIG. 2) are parallel to the long dimension or length 125 of the flip 106, or the pattern traces are perpendicular the hinge 126 edge 131, and substantially all of the circuitry 124 terminates proximal the hinge 126, there is no circuitry of the pattern traces along the sides 127 and 128 of the flip 106, nor along the bottom edge 129 of the flip. Beneficially, positioning the length of the pattern traces of the disclosed semi-transparent touch screen 104 of a low resistive mesh (see FIG. 3) vertically with respect to the length 125 of the flip 106 provides a more aesthetically pleasing device since no artwork around the edges of the flip 106 provides for a truly semi-transparent touch screen 104. That is, the first side edge 127 and the second side edge 128 of the flip 106 may be substantially transparent, as may be the bottom edge 129, since no artwork is necessary to conceal circuitry at these edges of the touch screen 104.

Similarly, in embodiments including rotator and slider form factors which both include two housings as does the clam shell form factor, the side edges and bottom edge of the housing are also semi-transparent. It is understood that any type of electronic device may utilize the described touch screen.

FIG. 2 illustrates pattern traces of the disclosed translucent touch screen device including a near-see-through mesh wherein pattern traces are vertical with respect to the length 125 (see FIG. 1) of the flip 106 housing. Touch zones of pattern traces 240 are formed by fine or microscopic cuts to isolate the zones or buttons from one another. The pattern traces 240 are configured to receive input to generate touch signals in their respective zones. For example, the pattern traces 240 may have a trace width to trace spacing ratio of 1:4. Many discrete touch zones may be available on the touch screen.

In one embodiment, the touch screen 204 may include twelve discrete buttons. However, in a mesh the size of a standard flip, in another embodiment, there may be as many as 1024×1024 points or input so there may be a higher number of buttons that can be detected since the buttons are virtual. The touch screen 204 may be arranged, for example, in a 4 column by 3 row configuration. This arrangement creates 12 discrete touch zones but each zone can sense a finger or conductive stylus no matter where the finger or stylus is applied on the screen. A touch screen controller IC (not shown) may be configured so that the four-zone width along a single row can be logically divided into 1024 virtual sections. Each of the four zones along a row may sense an applied finger or stylus.

A touch screen design using a low resistive material typically includes discrete resistor components added so that the touch screen controller can better sense a change in resistance and determine the position similar to the way a controller determines the position on an ITO touch screen. Since the resistors are not translucent, the touch screen pattern using low resistive material is rotated 90 degrees counter-clockwise so the pattern is now vertically orientated and the resistors can be placed under the hinge artwork.

The resistance increases as the length of the trace increases due to the added discrete resistors on the PCB 244. The touch screen controller IC uses the resistance values to determine where an applied finger or conductive stylus is located among zones, for example four zones, in the row, to the resolution of 1024 virtual points. The controller IC may carry out a similar calculation, for each row of the column, to determine the vertical position. In this case the columns have three rows, or zones, and the controller IC can divide a column into 1024 virtual sections. Therefore, the controller IC can use the 12 zones to calculate a position within a 1024×1024 array. A higher number of touch zones can provide better resolution within a 1024×1024 array. In such an embodiment, the touch screen 204 may be a full XY touch screen and having virtual buttons so their number may be limited, for example, by the user interface requirements of the mobile communication device 102 (see FIG. 1).

It is understood that any suitable trace width to trace spacing ratio to provide a translucent touch screen is within the scope of this discussion. A smaller trace width to trace spacing ratio may make the touch screen material appear more translucent. In any case, a small trace width to trace spacing ratio is dependent upon the low resistivity of the mesh (see FIG. 3). In this way, more touch zones are possible. As mentioned above, the main display 110 (see FIG. 1) on the main housing 112 may be viewed through the touch screen 204 of the flip 206 so that a user may utilize menus of the main display 110 while the clam shell device is in the closed position. The touch zones of the pattern traces 240 when touched may be responsive to indicia on the main display.

In the disclosed touch screen device the substantially vertical pattern traces 240 are parallel the first side edge 227 and the second side edge 228 of the flip 206 of the device 202. Since the pattern traces 240 are vertical with respect to the length 225 of the flip 206, and the circuitry 124 (see FIG. 1) terminates proximal the hinge 126, there is no circuitry of the pattern traces along the sides of the flip 127 and 128, nor the bottom edge of the flip 129.

To connect the pattern traces 240 to circuitry 242 of a larger electronic device 102 (see FIG. 1) to receive touch signals PCB may be laminated or otherwise attached to the mesh (see FIG. 3). The circuitry 242 may include resistors 244 added to the main PCB, for example, to offset the low resistivity of the conductive material of the mesh, to meet resistance requirements of the circuitry. Accordingly, when the flip of a clam shell form factor mobile communication device 102 (see FIG. 1) is closed, and indicia 108 of the main display 110 may be viewed through the semi-transparent touch screen of the flip incorporating the disclosed touch screen utilizing a mesh of low resistivity, by the ability to include more touch zones, the functionality of the device in the closed position is improved over a device utilizing an ITO touch screen having substantially fewer touch zones.

FIG. 3 depicts the disclosed mesh 350 of a low resistive material utilized for the disclosed touch screen 304, a portion 352 of which is shown as an enlargement 356 thereof. The mesh 350 is shown with a bias direction of the mesh parallel to the horizontal and vertical directions. The mesh 350 may be formed, for example, through printing, masking and a blackening process.

As discussed above, a clam shell form factor mobile communication device 302 includes a hinge 126 (see FIG. 1) configured to join the main housing to the flip 306 at the top of the flip 359. The top edge 359 of the flip 306 is routinely covered by artwork 360 which is shown in the figure in dashed outline 331 so that the circuitry 324 is still visible in the figure. The artwork may also cover the circuitry 242 (see FIG. 2). As mentioned above, PCB may be laminated or otherwise attached to the mesh 350 to connect the pattern traces 240 to circuitry 242 of a larger electronic device 102 (see FIG. 1). Accordingly, the described circuit elements of the touch screen 304 and other features may be hidden by the artwork 360. In other embodiments, the circuitry may be kept to one edge, so that only one edge needs to be proximal to artwork. It is understood that the artwork hiding the circuitry and other elements of the device at one edge of the touch screen may have any suitable configuration. In the slider form factor, or the rotator form factor, the edge chosen for the artwork may be different that that of the presently discussed clam shell form factor. Moreover, in other devices, the edge to include artwork may be any suitable edge. In this way, the disclosed unframed semi-transparent touch screen may provide advanced features and maintain an edge in design trends.

It may be beneficial to form a mesh-film and plastic combination. Accordingly, the mesh 350 is supported by the film 354 with the flip 106 (see FIG. 1) housing and components may be attached to the combination by for example a heat process such as lamination. In the illustrated embodiment of FIG. 3, the mesh 350 has been deposited on a polyethylene terephthalate (PET) film 354 or any suitable film which was then molded with the flip housing 106 by for example a heat process to form a mesh-film and plastic combination. The PET film may have for example, a 0.125 mm thickness. The film 354 may be etched to isolate pattern traces 240 (see FIG. 2) when the mesh 350 is deposited on the film 354. Additionally, a heat process, such as inmold labeling technology, may be applied to form a clear clam shell form factor flip housing. Moreover, the circuitry 324 of the previously mentioned PCB may be laminated to the PET film 354 with heat sealing. Heat processes can include less processing than for example, forming a product by an adhesion process. The film 354 may beneficially support the mesh 350, and in particular when an electronic component such as a speaker is applied to the mesh 350.

The mesh 350 may be of a conductive material having a low resistivity value, and may be in particular less than approximately 3.0 ohms per mm². Any such material that may be configurable as a mesh, such as copper, silver, gold and alloys thereof, may be utilized. Dimensions of the mesh 350 may be, for example, approximately 300 μm pitch, 10 μm width and 12.5 μm thickness. It is understood that any suitable material may be used for the mesh 350 so that it has a low resistivity value. The low resistivity value provides that the pattern traces formed in the mesh 350 may be narrower than those of pattern traces of the glass-like ITO material.

Disclosed is a translucent touch screen device of a mesh composed of a low resistive material configured so that the length of the pattern traces of the disclosed semi-transparent touch screen are arranged in the vertical direction, their circuitry terminating at one edge of the mesh. Accordingly, there is no need for silver ink or other circuitry at the other edges of the mesh. Beneficially, the above-described semi-transparent touch screen beneficially does not include any artwork on the sides or the bottom of the flip. The circuitry coupled to the pattern traces of the mesh to receive touch signals is proximal the hinge edge, which is covered by artwork. Also disclosed are embodiments including rotator and slider form factors including the disclosed touch screen configuration. Thus, the terminal end of the pattern traces of the disclosed mesh is hidden by artwork at the hinge while the side edges and bottom edge are unframed and therefore semi-transparent in an aesthetically pleasing manner. Accordingly, the disclosed unframed semi-transparent touch screen may provide advanced features and maintain an edge in design trends.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A mobile communication device having a clam shell form factor, comprising:
a first housing and a second housing coupled by a hinge, wherein the second housing is a flip, wherein the flip includes a hinge edge, a bottom edge, a first side edge and a second side edge;
a translucent touch screen device including a near-see-through mesh wherein pattern traces are formed in the mesh, the pattern traces being configured to receive input to generate touch signals, wherein the touch screen device is incorporated into the flip so that the pattern traces are parallel the first side edge and the second side edge; and
circuitry coupled to the mesh to receive touch signals, the circuitry coupled to a controller to control at least one function of the mobile communication device according to the touch signals,
wherein the circuitry is proximal the hinge edge.

2. The mobile communication device of claim 1, wherein the mesh is of a conductive material having a resistivity less than approximately 3.0 ohms per mm².

3. The mobile communication device of claim 2, wherein the conductive material is copper.

4. The mobile communication device of claim 2, wherein the circuitry comprises resistors to offset the low resistivity of the conductive material to meet a resistance requirement of the circuitry.

5. The mobile communication device of claim 1, wherein the first side edge and the second side edge are substantially transparent.

6. The mobile communication device of claim 1, wherein the bottom edge is substantially transparent.

7. The mobile communication device of claim 1, wherein the mesh is molded to a film, the device further comprising PCB laminated to the film proximal the hinge to connect the pattern traces to circuitry components of the circuitry.

8. The mobile communication device of claim 1, wherein:
the first housing includes a display screen configured to display indicia; and
the display screen of the first housing is configured to display indicia thereon so that the indicia are visible through the touch screen device of the flip so that input received by the touch screen device is responsive to indicia displayed on the display screen of the first housing.

9. The mobile communication device of claim 1, wherein:
the mesh has a bias; and
the mesh is positioned with a bias direction of the mesh parallel to the hinge.

10. The mobile communication device of claim 1, wherein the touch screen is capacitive.

11. A mobile communication device having a clam shell form factor, comprising:
a first housing and a second housing coupled by a hinge, wherein the second housing is a flip, wherein the flip includes a hinge edge;
a translucent touch screen device including a near-see-through mesh wherein pattern traces are formed in the mesh, the pattern traces being configured to receive input to generate touch signals, wherein the touch screen device is incorporated into the flip so that the pattern traces are perpendicular the hinge edge; and
circuitry coupled to the mesh to receive touch signals, the circuitry coupled to a controller to control at least one function of the mobile communication device according to the touch signals,
wherein the circuitry is proximal the hinge edge.

12. The mobile communication device of claim 11, wherein the mesh is molded to a film, the device further comprising PCB laminated to the film proximal the hinge to connect the pattern traces to circuitry components of the circuitry.

13. The mobile communication device of claim 11, wherein the hinge is proximal to artwork, the artwork at least in part obscuring the circuitry.

14. The mobile communication device of claim 11, wherein the mesh is of a conductive material having a resistivity less than approximately 3.0 ohms per mm².

15. The mobile communication device of claim 11, wherein the mesh is copper.

16. A mobile communication device having at least one of a rotator form factor and a slider form factor, comprising:
a first housing and a second housing moveably coupled, wherein the second housing is a moveable housing with respect to the first housing, wherein the moveable housing includes a top edge, a bottom edge, a first side edge and a second side edge;
a translucent touch screen device including a mesh and a film molded to the mesh wherein pattern traces are formed in the mesh, the pattern traces being configured to receive input to generate touch signals, wherein the touch screen device is incorporated into the moveable housing so that the pattern traces are parallel the first side edge and the second side edge; and
circuitry coupled to the mesh to receive touch signals, the circuitry coupled to a controller to control at least one function of the mobile communication device according to the touch signals,
wherein the circuitry is proximal at least one of the top edge and the bottom edge of the moveable housing.

17. The mobile communication device of claim 16, wherein the mesh is of a conductive material having a resistivity less than approximately 3.0 ohms per mm².

18. The mobile communication device of claim 16, wherein the first side edge and the second side edge of the moveable housing are substantially transparent.

19. The mobile communication device of claim 16, wherein the bottom edge of the moveable housing is substantially transparent.

20. The mobile communication device of claim 16, further comprising flexible PCB laminated to the film proximal the top edge of the moveable housing to connect the pattern traces to circuitry components of the circuitry.
